(19) United States
(12) Patent Application Publication
(10) Pub. No.: US 2025/0263920 A1
(43) Pub. Date: Aug. 21, 2025

(54) Modular building

(71) Applicants: ASSOCIAÇÃO CECOLAB - COLLABORATIVE LABORATORY TOWARDS CIRCULAR ECONOMY, Oliveira do Hospital (PT); BLC3 EVOLUTION, LDA, Oliveira do Hospital (PT)

(72) Inventors: Filipa Daniela FRANCISCO DE FIGUEIREDO, Oliveira do Hospital (PT); João Miguel DOS SANTOS ALMEIDA NUNES, Oliveira do Hospital (PT); João Manuel NUNES PEREIRA CID TELES, Oliveira do Hospital (PT)

(73) Assignees: ASSOCIAÇÃO CECOLAB - COLLABORATIVE LABORATORY TOWARDS CIRCULAR ECONOMY, Oliveira do Hospital (PT); BLC3 EVOLUTION, LDA, Oliveira do Hospital (PT)

(21) Appl. No.: 18/856,966

(22) PCT Filed: Apr. 11, 2023
(86) PCT No.: PCT/IB2023/053701

§ 371 Date: Oct. 15, 2024

(30) Foreign Application Priority Data
Apr. 13, 2022 (PT) 117908

(51) Int. Cl. E04B 1/34

(52) U.S. Cl. CPC E04B 1/3404

(57) ABSTRACT

The present invention describes the construction of sustainable modular buildings from end-of-life or reused wind turbine segments, promoting the circular economy and the “zero waste” concept. It discloses a modular building that follows structural mechanics and architecture strongly influenced by the introduction of wind turbine tower and blade segments at the end of their useful lives. The hollow section part of the tower will form the rigid core and the blades will form pillars and connecting beams that join these pillars to the central core. Valuing the hollow internal space of the components, there is also the incorporation of a fire fighting and safety system using a water circuit inside the structure, at the same time that it houses networks of the different tubes and pipes of the specialties present in a building. To improve anti-seismic behaviour and vibration control, cork is used as a connecting element and constituent of the expansion joints between structural elements.

### TECHNICAL DOMAIN

The present invention is part of the sustainable, safe construction, circular economy and renewable energy sectors. The invention refers to a modular building that follows structural mechanics and architecture strongly influenced by the introduction of end-of-life wind turbine segments. In this way, the invention is also a circular economy solution to the problem of wind turbine towers and blades at the end of their useful life, as it makes use of these segments for the structure of the modular building, while also providing the structure with pipes for primary networks against fire, electrical and communication networks, and gas and water distribution networks. The invention also has a fire-fighting and safety system (FFSS) incorporated inside the main structure, which makes use of a new positioning of the fire protection network in infrastructures, which gives a greater degree of protection to the building. Within an anti-seismic construction and structural vibration control logic, the invention also includes the use of cork to materialize the expansion joints.

### BACKGROUND

For the presentation of the invention, it is important to present some points that inspired it, principles that it intends to follow and problems it seeks to solve. These points and principles are the valuation of waste generated by wind turbines at the end of their useful life, the concept of “Zero Waste”, the importance of fire-fighting and safety systems in buildings and the use of cork or similar composites/materials with negative contraction capacity and shape memory materials in construction.

Wind energy is currently one of the fastest growing types of renewable energy. According to data from IRENA (International Renewable Energy Agency), global installed capacity from 1997 to 2018 has increased by about 75 times, from 7.5 GW to 564 GW. According to Wind Europe, currently in Europe, 34 thousand wind turbines are at least 15 years old, which represents 36 GW of onshore installed capacity. Of these 36 GW, around 9 GW are between 20 and 24 years old and 1 GW is 25 years old or more. Considering the standard lifetime of between 20 and 25 years, the number of wind turbines to be dismantled will increase, which may become a waste problem. Although some repowering and life extension actions are being implemented to increase the profitability of wind turbines, there shall always be an end of life of the equipment.

Although wind turbine towers do not represent a high concern from a reuse point of view, since they are made of concrete and/or steel, the same does not apply to the blades. In order to achieve higher efficiencies, the blades are manufactured with composite materials, containing fiberglass, carbon fiber, or polymers. Since recycling is a very rare resource for this equipment, usually it is discarded in landfills, which poses a threat to the environment. To date, there are not many regulated requirements for composite waste, however, the incentive for circular economy is very present in the “Action Plan for Circular Economy” launched in 2020 by the European Commission. According to Zero Waste International Alliance (ZWIA), the term “Zero Waste” is defined as, “The conservation of all resources through the responsible production, consumption, reuse and recovery of products, packaging and materials without burning or discarding into land, water or air that threatens the environment or human health.” This is a concept of great importance in projects that aim at sustainability and that intend to achieve Circular Economy.

Some of the attempts being carried out at present, with a view to reusing/using waste from the dismantling of wind turbines, focus on recycling the materials used in their construction. Currently, wind blades, which are made of fiberglass, are crushed and the resulting fibres are applied in the manufacture of new wind blades. In some situations, they can also be applied in the construction sector, namely in the reinforcement of concrete structures. However, this reinforcement is achieved by introducing previously crushed fibres into the concrete itself, which will eventually produce positive effects in terms of tensile strength or the prevention of cracking phenomena. An entire process with high expenditure of energy is therefore necessary so that the grinding of the fibrous material of the blades is processed.

On the other hand, in projects for the construction of buildings, one of the most important requirements is safety in case of fire. In addition to all safety and security systems for occupants, the protection of the structure itself is a crucial point. As such, it must have load-bearing capacity, resistance to fire penetration and resistance to excessive heat transfer, so that collapse in case of fire is avoided. Phenomena such as “spalling” in reinforced concrete structures often occur due to the high temperatures provided by the action of fire. In this phenomenon, the water molecules present in the concrete structure change to a gaseous state, generating an increase in vapor pressure inside its pores. This vapor usually has difficulty escaping into the surrounding environment, which leads to the sudden appearance of high internal stresses in the concrete, which could lead to its brittle failure. This failure occurs explosively and is accompanied by a crash and results in the separation of the concrete from the reinforcements, which are then exposed to fire, which compromises the structure's bearing capacity. With metallic structures, the high temperatures caused by the action of fire drastically reduce the resistance of its elements. Steel, which is a material with high thermal conductivity, heats up quickly as a result of the temperatures caused by fire, eventually giving way, deforming drastically and eventually breaking, causing the collapse of the structure it constitutes.

Another problem commonly seen in buildings has to do with filling expansion joints and transition joints between elements. Expansion joints are necessary to release tensions occurring in the material environment and that are the result of volume variations due to the thermal amplitudes undergone by the materials or variations in water content observed in some materials. Transition joints are often necessary to materialize the transition between different materials with different rheological behaviour. These joints are sometimes left untreated or filled with highly elastic materials such as mastic. Cork, in turn, is a material that is already well known for its excellent properties and applications. It is a 100% natural, reusable and recyclable material, being, from an environmental, social or economic point of view, one of the most versatile materials in the world. Cork structure is similar to a honeycomb with microscopic cells filled with a gas similar to air, which occupies about 90% of its volume. It has an average density of 200 kg/m³, and shows very interesting characteristics such as: excellent acoustic and thermal insulation, excellent resistance to fire and combustion, excellent elasticity and compressibility, it is extremely light and buoyant, hypoallergenic, impermeable to liquids and gases and has high resistance to friction, which makes it a very interesting material for certain applications in construction. One of these applications is the treatment of the aforementioned expansion and transition joints.

### SUMMARY

The present application describes a modular building characterized in that it comprises a constructive structure composed of wind turbine segments, said constructive structure comprising at least:
a set of foundation rings, structurally adapted to the ground supporting the building;
a foundation balance platform, mechanically connected to the set of foundation rings;
a set of outer support structures;
a set of upper support structures, placed parallel in a position superior to the foundation balance platform, and guaranteeing a mechanical connection to the set of outer support structures; and
a support structure, positioned centrally in relation to the foundation balance platform, mechanically connected to said foundation balance platform and to the set of upper support structures.

In one embodiment, the modular building is characterized in that the set of foundation rings and/or the support structure comprise transverse annular sections of at least one wind turbine tower.

In one embodiment, the modular building is characterized in that the foundation balance platform comprises at least one shape selected from circular, oval, rectangular, parallelepiped or triangular.

In one embodiment, the modular building is characterized in that the set of outer support structures comprises at least one inner blade section of at least one wind turbine.

In one embodiment, the modular building is characterized in that the set of upper support structures comprises at least one outer blade section of at least one wind turbine.

In one embodiment, the modular building is characterized in that the mechanical connection between the support structure and the set of upper support structures comprises a blade connection and bearing support, and a lower expansion joint.

In one embodiment, the modular building is characterized in that the set of upper support structures comprises a plugging panel and an upper expansion joint mechanically connected thereto in order to promote the reinforcement of the mechanical connection to the support structure.

In one embodiment, the modular building is characterized in that the support structure comprises at least one elevator adapted to an inner structure thereof.

In one embodiment, the modular building is characterized in that it comprises a fluid pressurized hydraulic system adapted to the constructive structure to promote heat dissipation or heating thereof.

In one embodiment, the modular building is characterized in that the inner blade sections comprise inner areas adapted to house a fire fighting and safety system.

In one embodiment, the modular building is characterized in that the inner areas of the inner blade sections comprise conducts, pipes and/or cabling of different specialties.

In another embodiment, the modular building is characterized in that the lower expansion joint and/or the upper expansion joint comprise cork.

In another embodiment, the modular building is characterized in that it comprises at least one floor slab adjacently located in a parallel position with respect to the foundation balance platform, in a parallel position underlying the set of upper support structures, and dimensionally equal to at least a floor slab.

The present application also describes the construction method of a modular building, which is characterized in that it comprises the steps of:
i. connecting the inner blade sections with the outer foundation rings through anchor bolts or threaded anchors embedded in the filling material of the foundation rings;
ii. connecting the support structure and the central foundation ring through anchor bolts or threaded anchors embedded in the filling material of the foundation rings;
iii. adapting a lower expansion joint to the blade connection and bearing support by means of a set of pins passing through the holes therein;
iv. drilling the widest end of each outer blade section promoting the engagement of the bearing support pins with the blade connection and bearing support;
V. fixing the pins by means of rivets, or another suitable fastening system, after fitting and aligning each of the outer blade sections;
vi. placing the plugging panel of the blade connection over the upper expansion joint by means of welding, riveting, screwing, or other technically suitable means;
vii. installing the finishing panel on top of the structure;
viii. installing an expansion joint at each existing intersection point between the top of each inner blade section and the outer blade section that fills the connection area between said blade sections, said expansion joint being comprised of cork, or a material with similar properties, to promote strain recovery due to its negative contraction properties.

### BRIEF DESCRIPTION

The invention aims to present a solution based on circular economy for the construction of sustainable modular buildings. It intends to assume itself as a solution to the problems of waste from wind turbines. In this way, the invention seeks to make use of sustainable materials in the Construction sector, as well as to provide a more effective response in fire fighting and safety systems (FFSS).

For the issue of end-of-life wind turbine waste (tower and blades), the invention aims to promote circular economy and “zero waste” concept. The present invention consists of a modular building, wherein end-of-life wind turbine segments are used as part of its structure, promoting multi-functional reuse.

The wind turbine tower can be segmented into annular transverse sections, and each of these sections can play a role in the constructive structure of a modular building:
1) the function of a central assuming a preponderant role in the stability of the building;
2) the function of an elevator well, providing an element with sufficient rigidity, room and diameters for the installation and service of an elevator responsible for the communication between floors;
3) the function of a duct through which air ducts and the piping and cabling necessary to comply with specialty projects (commonly water supply, wastewater drainage, HVAC, fire fighting and safety system) can be arranged.

In turn, wind turbine blades are also used as part of the constructive structure of the modular building. These are integrated into the construction in two ways: as outer vertical pillars and as beams connecting these pillars to the central column.

Due to its high length, the wind turbine tower is not entirety used as a central column of the modular building structure. In order to achieve the “zero waste” concept according to the invention, the sections of the tower which are not used as a structure, serve as foundation elements, as rings for the footings, or as filling material, since leftover waste could occasionally be processed in order to guarantee metallic fibres or any other form that can be mixed with the concrete used to fill them (with possible gains in the resistance of the concrete in the face of tensile stress or facilitating the control of cracking of this material).

The invention also has the objective of presenting a solution for fire situations through the installation of a Fire Protection System (Fire-fighting and Safety System-FFSS). As described, the modular building has the wind turbine tower as part of the structure built in steel and the blades mostly made of composite material (fiberglass) which can be a problem if they are not properly protected. In case of fire, with the increase in temperature caused by fire, steel structures and composite materials tend to lose mechanical properties. Protection with concrete, mortars and fibres, such as stone wool, is sometimes not enough, as they only delay the transfer of heat to the structure. The solution to this problem according to the present invention involves providing a pressurized fluid hydraulic system adapted to the constructive structure consisting of the circulation of fluids, in particular water, within the structure itself. As such, the building is equipped with pressurized fluid conduits inside the tower, the blades and other elements of the structure, which can, for example, use water supplied by the public network. The system has two functionalities: on the one hand, it acts as a heat exchanger, since the circulation of fluids, in particular water, allows the cooling of the structural elements (it promotes the transfer of heat from these elements to the circulating fluid, which is at lower temperatures), reducing the temperature of the structure as a whole. On the other hand, the system can be used as a means of extinguishing a fire and is prepared to supply water to the interior of the building for the purpose of extinguishing thereof. In the same system, in case of failure in its pressurization or in the event of a need to use a certain extinguishing agent, it is possible to inject extinguishing agents directly into the hydraulic system of the building, through an hydrant accessible to firefighters and other rescue and safety teams.

In order to prevent and mitigate the phenomena described above, fire safety in buildings acts a lot on the prevention perspective, but also on the protection perspective, ensuring thermal and gas detectors, armed fire networks and sprinklers or other types of automatic or manual actuators, for example, and on the structural protection perspective, promoting measures such as the protection of metallic elements with intumescent paint or light projected mortars.

Due to the complexity and materials used from wind turbines for the structure, the invention faces some problems such as expansion, vibration and freedom of movement. Due to their mechanical properties and sustainability, cork composites are presented in the invention as a solution for connecting elements and expansion and transition joints in the building structure. The invention uses this material with the functions of damping, vibration control, expansion or contraction freedom the of structural elements and resistance to fire and combustion.

Due to its Poisson coefficient close to zero, in the case of compression or traction, the expansion or retraction of the cork pieces, in transverse dimensions to the request, is practically null. Cork expansion joints ensure that displacements caused by wind, temperature variations, foundation settlements (up to a certain magnitude) and seismic activity do not have negative impacts on the structure. Due to the properties presented, it is believed that cork is a valid solution for this concept of sustainability in construction.

Other aspects and advantages of the present invention may be better understood by reading its detailed description which includes reference to the accompanying figures, which are intended to be discussed in conjunction with the textual descriptions.

The invention may, however, be embodied in and in many different forms and is not to be construed as limited to the embodiments set forth herein; rather, these embodiments are provided by way of illustration only and not by way of limitation.

### BRIEF DESCRIPTION OF THE FIGURES

For an easier understanding of the present invention of a modular building built using end-of-life wind turbines, figures are herein attached, which represent embodiments which, however, are not intended to limit the technique herein disclosed.

FIG. 1 illustrates a three-dimensional schematic representation of the exterior of a modular building wherein the upper panel with the function of creating low pressure areas and providing all natural ventilation mechanics of the same building can be seen. The numbers shown refer to: (5) Blade expansion joint; (9) Blade connection plugging panel; (10) End panel; (12) Covering slab; (13) Floor slab; (201) Inner blade section; (202) Outer blade section.

FIG. 2 illustrates a three-dimensional schematic representation of a wind turbine, wherein numbers shown represent: (1) Tower; (2) Blade.

FIG. 3 illustrates a three-dimensional exploded schematic representation of the wind turbine dismantling for use in the modular building, wherein numbers shown represent: (1) Tower; (101) Support structure; (102) Foundation rings; (103) Top of the tower; (2) Blade; (201) Inner blade section; (202) Outer blade section.

FIG. 4 illustrates a three-dimensional schematic representation of the structure for the building, wherein numbers shown represent: (101) Support structure; (102) Foundation rings; (201) Inner blade section; (202) Outer blade section; (301) foundation balance platform; (4) Foundation radial balance beams; (5) Blade expansion joint; (6) Blade connection and bearing support; (601) Pins; (7) Bottom expansion joint; (8) Upper expansion joint; (9) Blade connection plugging panel; (10) End panel.

FIG. 5, like FIG. 4, illustrates a three-dimensional schematic representation of the structure for the building. This time, the foundation balance platform (301) shown in FIG. 4 gives way to a set of three straight balance beams that form a connecting triangle between the bases of the pillars formed by the bases of the blades, wherein numbers shown represent: (101) Support structure; (102) Foundation rings; (201) Inner blade section; (202) Outer blade section; (301) Foundation balance platform; (4) Foundation radial balance beams; (5) Blade expansion joint; (6) Blade connection and bearing support; (601) Pins; (7) Bottom expansion joint; (8) Upper expansion joint; (9) Blade connection plugging panel; (10) End panel.

FIG. 6 illustrates a schematic of the exploded three-dimensional representation of the structure for the building, wherein numbers shown represent: (101) Support structure; (102) Foundation rings; (201) Inner blade section; (202) Outer blade section; (301) Foundation balance platform; (5) Blade expansion joint; (6) Blade connection and bearing support; (7) Bottom expansion joint; (8) Upper expansion joint; (9) Blade connection plugging panel; (10) End panel.

FIG. 7 illustrates a schematic representation of the top of the building with emphasis on the expansion joints: (101) Support structure; (201) Inner blade section; (202) Outer blade section; (5) Blade expansion joint; (6) Blade connection and bearing support; (7) Bottom expansion joint; (8) Upper expansion joint; (9) Blade connection plugging panel.

FIG. 8a illustrates a schematic representation of the top of the building, wherein numbers shown represent: (201) Inner blade section; (202) Outer blade section; (5) Blade expansion joint; (10) End panel; (12) Covering slab.

FIG. 8b illustrates a schematic representation of the front view of the building, wherein numbers shown represent: (201) Inner blade section; (202) Outer blade section; (6) Blade connection and bearing support; (7) Bottom expansion joint; (8) Upper expansion joint; (9) Blade connection plugging panel; (10) End panel; (13) Floor slab.

FIG. 9 illustrates a schematic representation of the building along section A-A, wherein numbers shown represent: (101) Support structure; (102) Foundation rings; (201) Inner blade section; (202) Outer blade section; (301) Foundation balance platform; (5) Blade expansion joint; (6) Blade connection and bearing support; (7) Bottom expansion joint; (8) Upper expansion joint; (9) Blade connection plugging panel; (10) End panel; (11) Duct for conduits and cabling; (13) Floor slab; (141) Filling of the foundation ring; (15) Elevator; (16) Hollow area (negative of the connection between parts (6) and (9)).

FIG. 10 illustrates a schematic representation of the building along section B-B, wherein numbers shown represent: (102) Foundation ring; (201) Inner blade section; (3) Longitudinal section of radial balance beam; (142) Inside of the foundation ring.

FIG. 11 illustrates a schematic representation of the building along section C-C, wherein numbers shown represent: (101) Support structure; (201) Inner blade section; (11) Duct for conduits and cabling; (15) Elevator; (17) Stairs.

FIG. 12 illustrates a schematic representation of a possible embodiment of the fire-fighting system integrated into the building structure, wherein numbers represent: (18) Public water supply network; (19) Extension connection to the public water supply network; (20) Reservoir; (21) Piping connecting to the reservoir; (22) Hydropressor group; (23) Isolation valve; (24) Non-return valve; (25) Output to the heat exchange network; (26) Connection point (flanged); (27) Piping connecting to the network or means of external water supply; (28) Upward plumb supply to the Fire Safety Network in Buildings (Fire-fighting and safety system-FFSS); (29) Fire hydrants; (30) Detection and/or extinction means network; (31) Detection and/or extinction means.

FIG. 13 illustrates a schematic representation of a possible embodiment of the heat exchange system applied to a modular building element, where the numbers represent: (201) Inner blade section; (32) Heat exchange network; (33) Water inlet direction in the heat exchange network; (34) Water outlet direction in the heat exchange network.

FIG. 14 illustrates a possible cross-section of an inner blade section (201) according to another possible embodiment of the fire-fighting system integrated into the structure of the modular building, wherein numbers represent: (201) Inner blade section; (30) Detection and/or extinction means network; (31) Detection and/or extinction means; (35) Blade coating; (36) Blade (37) stringer; Detection and/or extinction means network plumb; (38) Hollow channel for passing networks of different specialties;

FIG. 15 illustrates a schematic representation of another possible embodiment of the fire-fighting system integrated into the structure of the modular building, wherein numbers represent: (201) Inner blade section; (202) Outer blade section; (30) Detection and/or extinction means network; (31) Detection and/or extinction means; (38) Hollow channel for passing networks of different specialties; (39) Water supply to the detection and/or extinguishing network of the inner blade section; (40) Water supply to the detection and/or extinguishing network of the outer blade section; (41) Inlet for networks of different specialties in the inner blade section; (42) Outlet for networks of different specialties in the inner blade section;

### DESCRIPTION OF THE EMBODIMENTS

Referring to the figures, some embodiments are now described in more detail, as well as other aspects and advantages in the construction of a highly sustainable building. The model presented is merely illustrative and can adopt several variants. It is important to emphasize that there are wind turbines of different models, dimensions and compositions, in the same way that a modular building can have different architectures, dimensions, structural options and purposes.

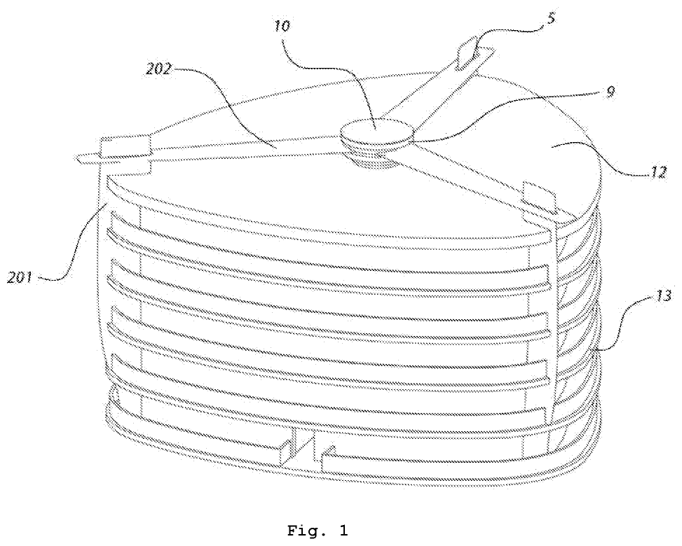

FIG. 1 illustrates a possible embodiment of the present invention. From the outset, it can be seen that the architecture of the modular building will always be strongly influenced by the characteristics of the segments of the dismantled wind turbine, not only in aesthetics, but also in dimensions. The use of dismantled wind turbine segments, such as blades and towers made of metallic, fiberglass, or any other material, in the construction process of the modular building and, specifically, as the materialization of various elements of its constructive structure, give it a unique circularity character, since end-of-life elements are reintroduced into value chains, many of which, in the absence of a reuse strategy, could even end up being deposited in landfills or permanently stored. An example of the use of these wind turbine segments are their blades, visible in FIG. 1, already segmented into an inner blade section (201) and an outer blade section (202). The use of existing materials and elements, with minimal adaptations to fulfil their new function, also confers sustainability to the building obtained with the present invention, which, otherwise, would have to make use of the transformation and processing of new natural resources. Environmental damage is avoided, which would be directly affected in the extraction sites of natural resources and in the consumed energy and pollution caused by their transformation processes. Also visible in FIG. 1 are the expansion joints (5) in the connection between the inner (201) and outer (202) blade segments, the plugging panel of the blade union (9), which joins the three outer blade segments (202), or as many segments as the invention supports, and the end panel (10), which is responsible for hiding the connection of the blades, giving a better aesthetic appearance and protecting this same connection from the action of external elements. The modular building of the present invention comprises a ground floor and one or more upper floors. The upper floors will be as many as the length of the blade segments and the various technical reasons admit and are materialized by the floor slabs (13) and covered by a roof slab (12).

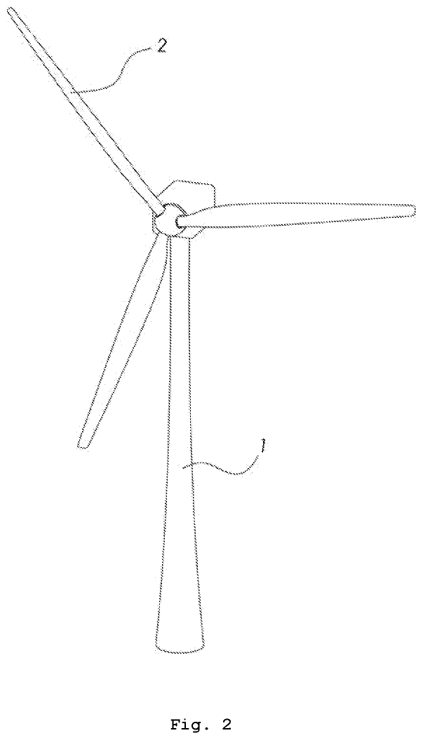

FIG. 2 represents a segmentation scheme of a wind turbine, wherein transverse annular sections of the tower (1) and sections of the blades (2) of end-of-life wind turbines are used to build the modular building described in the invention.

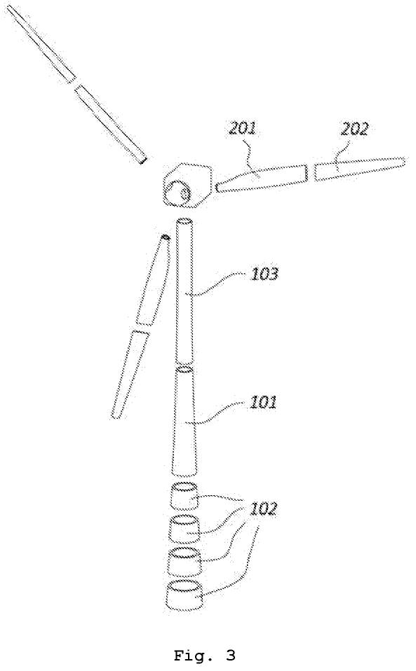

FIG. 3 represents the dismantling and cutting of the wind turbine parts that are used as part of the building structure. The tower (1) is separated into several sections for different purposes. The central part of the tower is used as a support structure (101) for the structure of the modular building. The lower sections of the tower (1), the foundation rings (102), are used for building the footings of the foundations and the top of the tower (103) can be used to produce fibers for filling the foundations together with a bonding material suitable for that role. As such, the top of the tower (103) can suffer processes of transformation of the metallic material thereof into metallic chips that can materialize fibres, be used in mixture with the poured concrete for the structural elements of the building, allowing to increase the resistance thereof to traction efforts or constituting a good solution for controlling cracks in floor and roof slabs, for example. According to the geometry and dimensions of each wind turbine, the part used as a support structure (101) may have to be different, in order to guarantee enough space inside for all the components. In this way, the foundation rings are dependent on the section of the tower used as a support structure (101). Obviously, the use of these sections of a wind turbine tower as foundation rings is dependent on what the structural calculation and the geotechnical calculation of the load bearing capacity of the foundation ground dictate. If their use is validated by calculation, these rings, after being properly protected against corrosion that can be induced by the soil, can “embrace” the entire footing, serving as a lost formwork.

Regarding the blades (2), these are separated into two parts—the inner blade sections (201) which are used as vertical columns of the building and the outer blade sections (202) which serve as connecting beams between the inner blade section (201) and support structure (101).

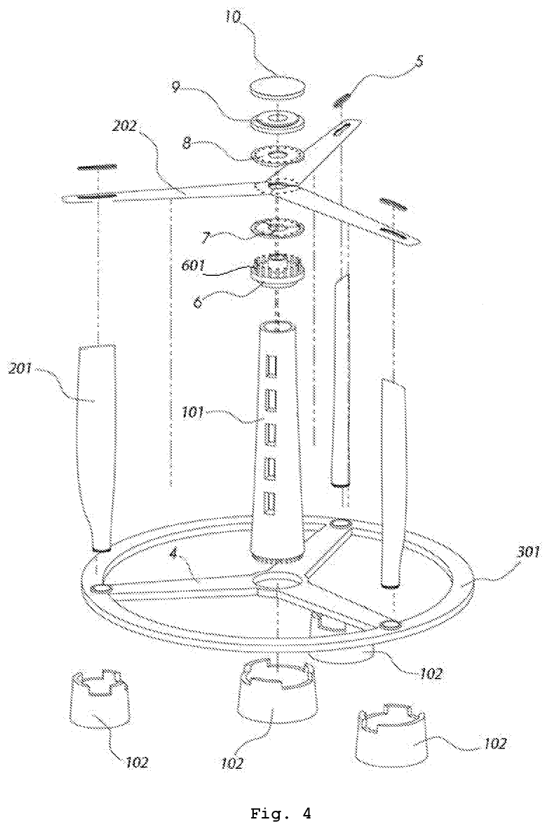

FIG. 4 shows a three-dimensional scheme in an exploded view to explain how the structure is assembled. Initially, the foundation for the building is prepared. As mentioned, the foundation rings (102) are initially installed for the construction of the footings, serving as formwork. The footing built with the foundation ring (102) serves as a base for the installation of the support structure (101), while the other footings built with the foundation rings (103, 104 and 105) constitute the supports for the outer vertical columns, formed by the inner blade section (201). As a reinforcement to the foundations and with the aim of increasing stability, a foundation base is built that interconnects all the foundation rings (102), in which case the functions of its arms are analogous to the functions performed by the foundation beams in a common building. These arms can take a circular shape, constituting what is here designated as the foundation balance platform (301), which can have any shape selected from circular, oval, rectangular, parallelepiped or triangular, and which connect to some foundation rings (102) of the pillars based on the inner blade section (201). They may also assume a rectilinear linear form, as represented by the radial balance beams of the foundation (4) that make the connection between the foundation rings (102). These connection beams can be materialized in reinforced concrete, for example, but also in any other material that fulfils the necessary requirements for that function and will be responsible for solidifying the different footings of the building, thus contributing to a better distribution of efforts at the level of the foundation, reducing the necessary section for each footing and mitigating the effects of possible differential settlements of the foundation soil. Then, the inner blade sections (201) are installed vertically and connected to the foundation rings (102), at the points where the outer footings are located. This connection can be materialized by anchor bolts or threaded anchors embedded in the filling material of the foundation rings (102), such as, for example, concrete, wherein these same anchor bolts or threaded anchors can fit in existing holes in the base of each inner blade section (201), being then tightened by nuts at the ends that go through the base of each inner blade section (201), fulfilling a form of connection to foundations typically found in metallic structures of civil engineering. After the installation of the support structure (101), a piece is installed which is herein designated blade connection and bearing support (6) which serves as a base to support the outer blade sections (202). As this support has a kind of teeth, these eventually go through the holes present in the outer blade sections (202), riveting them and keeping them sufficiently solidary with each other. As connecting elements, the expansion joints of the blades (5), made from cork compounds, are applied which act as a contact element between the inner blade section (201) and the outer blade section (202). In the same way and with the same material, the lower expansion joint (7) is applied to the blade connection and bearing support (6).

Then, the outer blade sections (202) are installed horizontally, perpendicular to the inner blade sections (201) and in a radial position with respect to the support structure (101), as shown in FIG. 4. Before being installed the plugging panel of the blade connection (9) (responsible for sealing the blade connection mechanism), the upper expansion joint (8) is applied. Finally, the end panel (10) is positioned, completing the vertical development of the central core of the building.

In more detail, the connection between the elements that join the outer blade sections (202) can assume the configuration shown in FIG. 4. According to this configuration, the blade connection and bearing support (6) has a set of pins (601) that pass through the holes present in the lower expansion joint (7), preferably made of cork, also passing through the holes present in the widest end of each outer blade section (202) and the constant holes in the upper expansion joint (8), whose preferred material is also cork. At this point, the pins (601) are riveted or receive a nut, depending on whether they have a smooth or threaded wall, thus being “stitched” the outer blade sections (202). The plugging panel of the blade connection (9) is then placed, by means of welding, riveting or screwing, plugging the entire connection below and receiving the end panel (10) as an aesthetic finishing and as a means of protection of the elements positioned below.

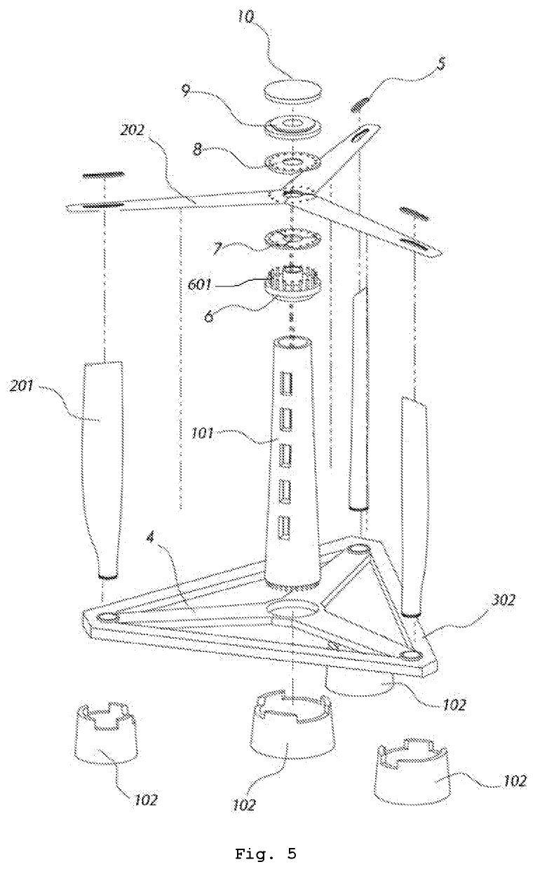

FIG. 5 represents the same exploded structure seen in FIG. 4, with the difference that in this one, at the level of the foundation, the interconnection of the foundation rings (102) is ensured by a foundation balance platform (301), a platform that can have any shape selected from circular, oval, rectangular, parallelepiped or triangular.

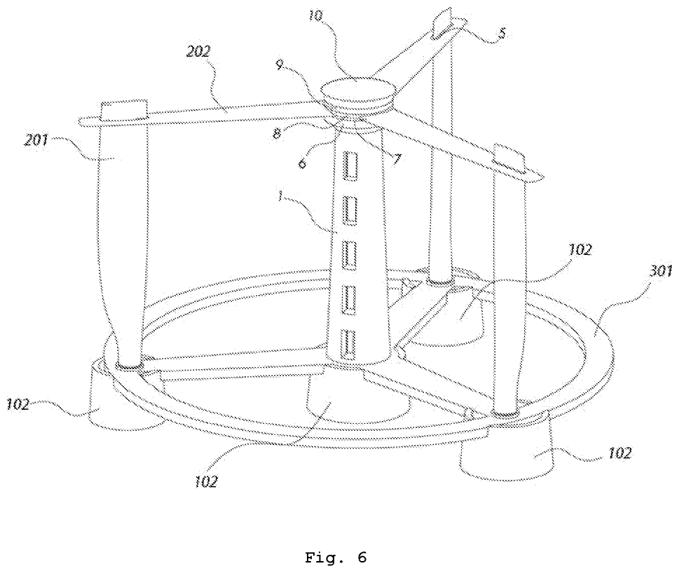

FIG. 6 shows a three-dimensional scheme of the assembled building structure, which is obtained after connecting all the constituents represented and described in FIG. 4. Depending on the dimensions of the building and the loads to which it is subjected, the structure shown allows reinforcement structures that must be adapted to each situation. Thus, to support the floor slabs and the roof slab, a whole set of pillars and beams may be foreseen in the project, executed in any material common in art or any other material that meets the regulatory requirements for verification of the ultimate limit states, deformation, and service. To lay the foundation of this supplementary structure, it may also be necessary to carry out a complementary foundation infrastructure.

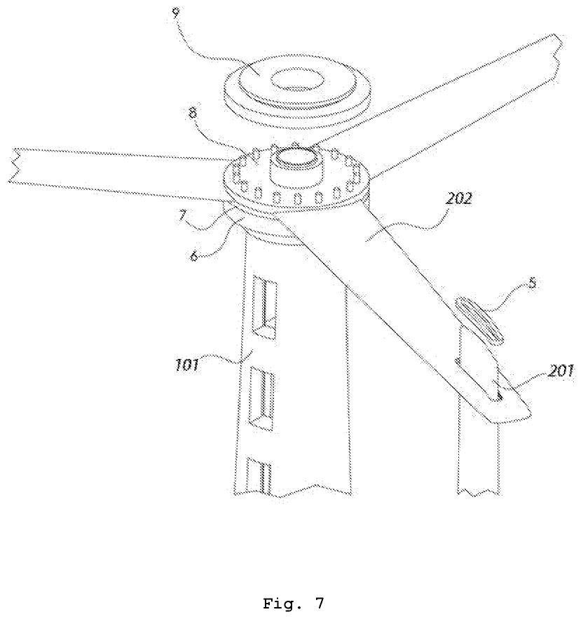

FIG. 7 serves as a supplementary image in order to demonstrate the function and position of the blade expansion joint (5), the lower expansion joint (7) and the upper expansion joint (8). It should be noted that, with regard to the expansion joint of the blades (5), it fills the entire connection contour between the inner blade section (201) and the outer blade section (202) and, preferably, materializes the connection between both sections by simple contact, with no other element responsible for this connection. By ensuring that it is the only connecting element between the blade sections, it takes advantage of the unique properties of cork which, given its Poisson coefficient close to zero, easily accommodates and compensates for deformations and relative movements between these same sections. This contributes to a good performance against seismic actions and improves the vibration propagation control between structural elements.

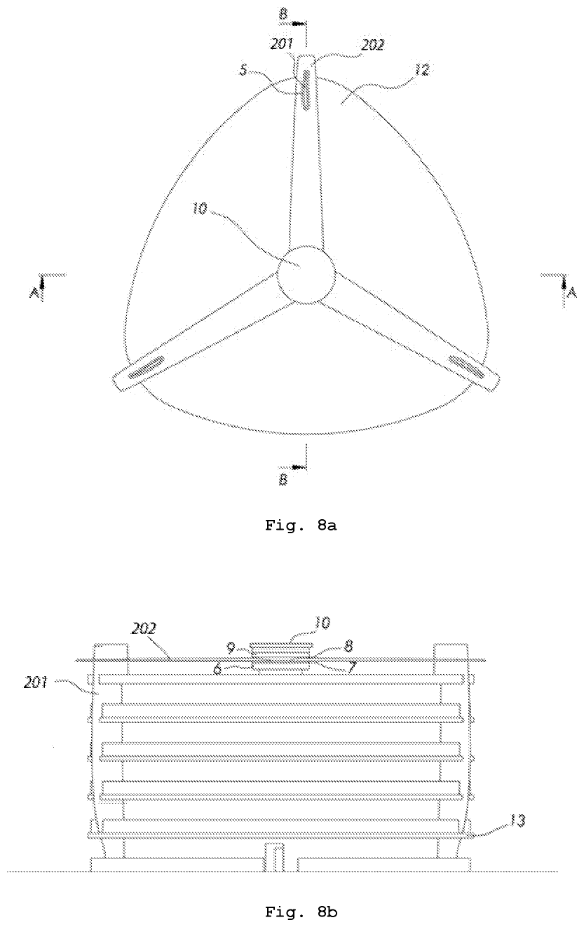

In FIGS. 8a and 8b the invention is represented in an assembly drawing in top view (FIG. 8a) and frontal view (FIG. 8b). While in FIG. 5 only the structure is represented, this figure shows the building already with the floors and masonry work carried out. In this example, the building has five floors, however this is a variable number, which depends on the model and size of the wind turbine and the needs of the project. In the set of illustrations represented in this figure, it is possible to see, among other elements already mentioned in the description of the previous figures, a possible shape for the slabs of the floors (13) and the roof (12). Regarding the assembly sequence of the structure, this can follow the sequence indicated when analysing FIG. 4, and the secondary structure, which also involves the execution of the floor slabs (13) and roof (12), can be erected between the positioning of the inner blade sections (201) and the positioning and connection of the outer blade sections (202), or even before or after the positioning of any of these. This order of execution will always depend on the contractor's strategy and the constraints imposed by each work and its place of execution. However, the execution of this structure, which comprises the floor slabs (13) and the roof slab (12), must always occur after positioning and executing the foundation rings (102), the foundation balance platform (301), the radial balance beams (4) and the support structure (101).

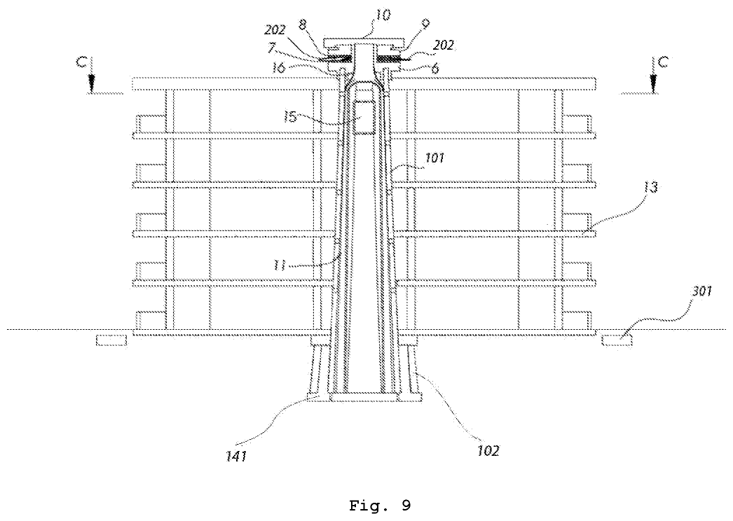

In order to expose the inner composition of the invention, a section view is presented along section A-A in FIG. 9. In this perspective it is possible to identify several components of the building. In addition to the roof slab (12) and the floor slab (13) and foundation elements, such as the foundation ring of the central column (102) and the filling of the foundation ring (141) and the longitudinal section of the radial balance beam (3), it is still possible to understand in detail the entire development of the central core of the building.

In this way, the support structure (101), part of the outer blade section (202), the blade connection and bearing support (6), the lower expansion joint (7) and the upper expansion joint (8), the plugging panel of the blade connection (9) and also the end panel (10) are visible in the central core of the building. As has already been said, the support structure (101) constitutes the rigid central core of the building, which is why it plays a fundamental role in the stability of its structure. It is assumed, therefore, as a large central pillar from which the slabs of the building are extended and where the beams materialized by the outer blade sections (202) are supported. But FIG. 9 also allows us to understand two more functions of this support structure (101). One of them is to constitute the elevator well (15), which, through openings arranged in the walls of this column (to accommodate doors), allows communication between floors. The hollow space (16), which is the negative of the connection between the blade connection and bearing support (6) and the plugging panel of the blade connection (9), can be used to house the elevator motor and all the equipment and winches necessary for the movement of that same elevator (15). Alternatively, and depending on the size of the wind turbine column used, this column can also constitute a stairwell core. The other function unveiled by the section in FIG. 9 is that of housing the duct for the passage of conduits and cabling (11). Thus, ventilation ducts for HVAC equipment, water supply pipes, domestic wastewater and rainwater drainage, fire safety pipes, gas supply ducts, electrical and telecommunications cabling can be stored herein. In this example, three of these ducts are represented (as seen in FIG. 11).

As shown, the footing is made up of the foundation ring (102) and the interior of the foundation ring (142) in concrete or other material with a suitable mechanical behaviour for the function and which also uses material from the top of the tower (106). This section also shows the longitudinal section of the radial balance beam (3) that interconnects the four footings (one central and three outer footing).

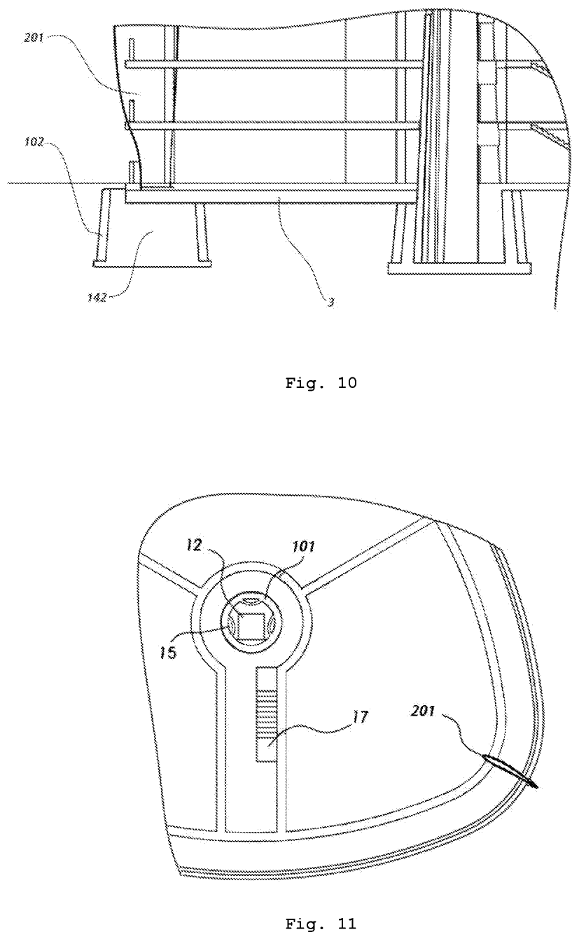

As a complementary view, FIG. 10 also shows part of the foundation of the building in detail. In this figure it is possible to see, in addition to the foundation ring of the central column (1b), one of the foundation rings (the ring (104)) of the pillars consisting in detail of the outer footing that supports one of the inner blade sections (201) This ring has filling (142), which can be made of concrete together with material used from the remaining sections of the tower of the dismantled wind turbine.

FIG. 11 is intended to demonstrate a cross-section with a top view to show the organization of the interior of the support structure (101). In the example shown, the building consists of three ducts for the passage of conduits and cabling ((11) and the elevator (15) installed inside the support structure (101). In the same figure, by way of example, a flight of stairs (17) is also visible, which is an alternative to using the elevator for communication between floors and which should always be part of the design of any building that respects the present invention.

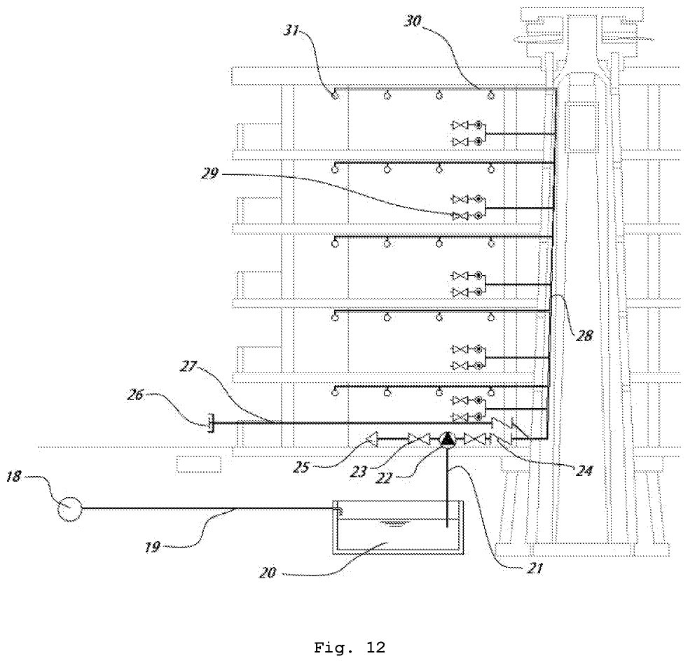

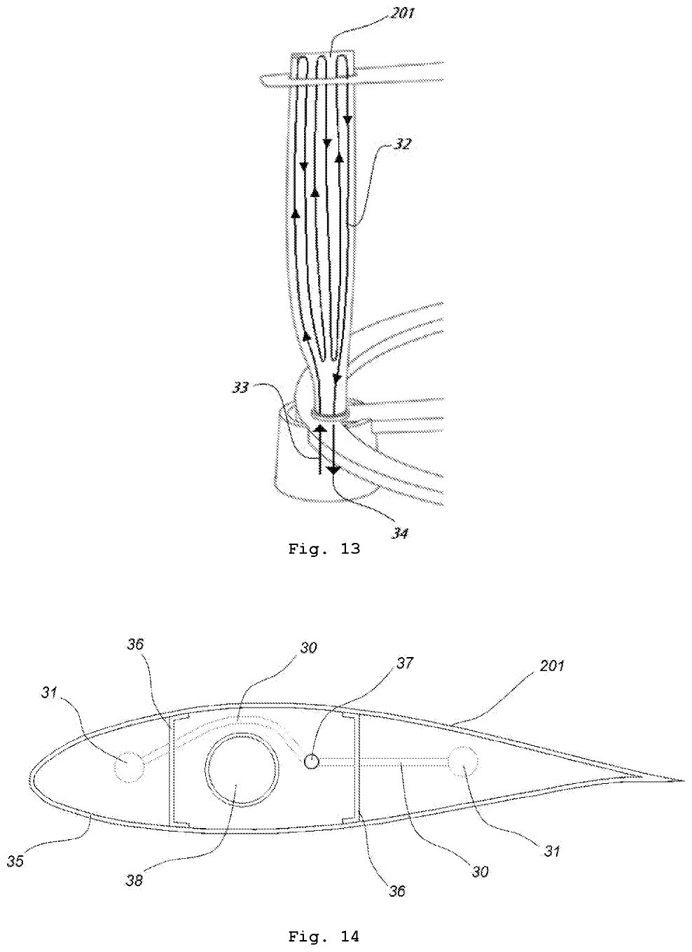

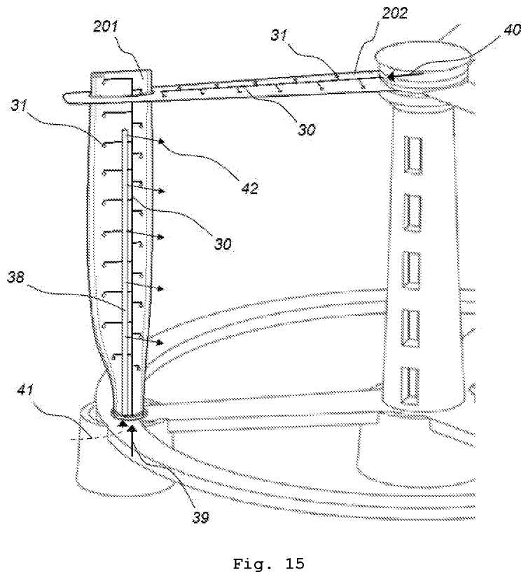

FIG. 12 shows a scheme of a possible configuration of a Fire-fighting and Safety System (FFSS) for the modular building treated in the present invention. The schematized system is just a possible example, and other FFSS solutions may fit into the present invention. The exemplified system is primarily fed by the public water supply network (18). The water is routed, through a connecting branch (19), to a reservoir (20), which aims at accumulating enough water to supply the entire FFSS network in the event of a flame ignition/fire breaking out at any point in the modular building. The represented network can be set (with water permanently in its pipe) or dry (water only fills it when the FFSS network is activated), although in the present example it is represented as a set network. Whatever the FFSS network designed for the building, it will comprise Fire Alarm and Detection Systems (FADS), which involves fire detectors of any type or other automatic or manual actuators and a fire control panel. If a fire is detected, the set of sensors provided by FADS will transmit the information to the fire control panel, which will take over the action of the FFSS network. In this way, one or more hydropressor groups (22) will be activated, supplying the FFSS network from the reservoir (20). The water will be fed into the pipe connecting to the reservoir (21), will pass through the hydropressor group (22) and will travel through the rest of the network, passing through the FFSS network supply riser (28) which will distribute it to each floor, depending on the location of the flame ignition/fire focus detected. It should be noted that, after the hydropressor group (22), there is a bifurcation in the network. Each direction assumed therein can be sectioned off by means of a sectioning valve (23) and, conveniently, it should also have a check valve (24) to prevent the return of the water injected into the FFSS network. At the aforementioned bifurcation, the water can supply the FFSS network of the building and can assume, independently or in parallel, the supply of a heat exchange network that also has a primordial function in terms of fire safety in this building (an example of this network applied to one of the elements can be seen in FIG. 13). The outlet for the heat exchange network (25) is also visible in FIG. 12. Alternatively, or even as a complement, the outlet for the heat exchange network (25) can be used to supply water to more branches of the Security and Fire Fighting Network in Buildings (FFSS). These branches can be directed towards a plurality of inner blade segments (201), being able to supply a network of detection and/or extinguishing means (30) or other automatic or manual actuators arranged inside those elements, taking advantage of the internal empty space they provide. This alternative of the FFSS system of the invention can be scrutinized in greater detail through the analysis of FIGS. 14 and 15. A differentiating characteristic of the present FFSS network relates to the possibility of it being supplied by an external means or supply network, that makes it possible to mitigate the unavailability of sufficient flows in the public network or even the complete failure thereof. To this end, the represented network has a derivation that constitutes the connection pipe to the external supply network (27), which culminates in a connection point (26) (flanged in the present representation). This connection point (26) allows coupling hoses that can be fed by an external supply network or by another means of extinguishing fires, such as a firefighting vehicle with a motor pump. This network can be fed under pressure, as is the case shown, and the network pressure is guaranteed by an external hydropressor group, and for this reason the connection to the FFSS network of the building takes place downstream of the hydropressor group of the building itself (22). Alternatively, the power supply may not be in pressure (situation not shown) and, in this case, the connection to the SCIE network of the building must be made upstream of its hydropressor group (22). Once water is found in the FFSS network of the building, it will be available on each floor through fire hydrants (29) and a network of detection and/or extinguishing means (30) installed on the ceilings of each floor, wherein each detection and/or extinguishing means (31) can trigger and ensure the extinguishment of the detected flame ignition/fire source.

FIG. 13 shows a schematic example of the heat exchange network provided in one of the modular building elements. In this case, the net is installed inside one of the interior blade sections (201) used in the construction of this building. This heat exchange network can be made up of piping made of any material with good mechanical and thermal resistance that is commonly found in water supply networks. The water inlet (33) in the heat exchange piping present in a given element is made in a certain direction, then following a serpentine path that constitutes the layout of the heat exchange network (32) of the element, ending up leaving in the opposite direction (34). The water that makes this route can be provided by a recirculation system that makes the same water repeat the route over and over again, always being cooled before each re-entry into the element. This heat exchange system can be present in any element, namely in concrete elements to prevent spalling phenomena. Water at a considerably lower temperature circulates through the interior of a given element which, under the action of fire, is at high temperatures. The temperature differential between the water circulating in the heat exchange network (32) and the element will tend to decrease, in accordance with the laws of thermodynamics. Thus, the circulated water tends to increase its temperature, but the temperature of the element exposed to fire drops, extending the maximum time of exposure of the element to fire. In order to avoid overpressures in the heat exchange network (32), which could be created by instantaneous vaporization of the percolated water once exposed to the high temperatures to which the structural element that houses it can be exposed in a fire situation, the same heat exchange network (32) can be equipped with overpressure safety valves. These valves, equipped with an automatic pressure gauge or any other device capable of measuring the pressure in the network at any moment, can release water that is about to vaporize. The heat exchange network (32), being suitably sensorized, can then replace more water at lower temperatures, which replaces the previously vaporized water that, for safety reasons, was released meanwhile.

In FIG. 14 a cross-section of the inner blade section (201) is visible. The cross-section taken as an example has an aerofoil shape typical of wind turbine blades, this shape being embodied in the blade covering (35). Internally, there is a lot of variability in the arrangement of the resistant structure of wind turbine blades. By way of example, as shown in FIG. 14, this structure can be composed, in addition to ribs not visible in the figure, of blade spars (36), with shapes as diverse as angled connectors or circular or rectangular tubular sections. In common, all blades have a large empty interior space that can be used. As such, the present invention, in one of its embodiments, takes advantage of the empty space available to accommodate part of the FFSS primary network and the primary network of different specialties commonly present in buildings, such as electrical and telecommunications network cabling, water supply pipes or gas supply pipes, for example. In this way, in the internal space of the blade, a hollow channel can be accommodated for the passage of networks of different specialties (38), which allows the passage of conduits, pipes and cabling associated with specialty networks, and also branches of the FFSS network of the building, housing at least one plumb network of detection and/or extinguishing means (37), the detection and/or extinguishing means network (30) and detection and/or extinguishing means (31). These elements of the FFSS network are fundamental for the protection of the inner (201) and outer (202) blade sections present in the building presented in this invention, providing an effective attack against fire whenever it is detected, contributing greatly to the increased safety of the entire structure. It should be noted that also the accommodation of primary networks of different specialties in the hollow channel for the passage of networks of different specialties (38) indirectly increases the fire safety of the building, since it allows diverting to peripheral points (further from the usable floors) segments of the primary electricity and gas networks which, due to possible short circuits in the first and leakage in the second, can so often constitute a fire focus.

FIG. 15 reveals an alternative embodiment of the fire safety system of the present invention and makes use of the ideas described in parallel with the analysis of FIG. 14. In this FIG. 15, the empty internal space present in each inner (201) and outer (202) blade section accommodates branches of the SCIE network of the building, such as the detection and/or extinguishing means network (30) (e.g., sprinklers, optical detectors, smoke detectors, temperature detectors, spark detectors, among others) or other automatic or manual actuators and detection and/or extinguishing means (31), and pipes, cabling and ducts of different specialties that run through the hollow channel for the passage of networks of different specialties (38). The detection and/or extinguishing means network (30) is, in its branch of the external blade section (202), supplied with water through the support structure (101), through the water supply point to the detection and/or extinguishing means of the outer blade section (40). The branch of the detection and/or extinguishing means network (30) present in the inner blade section (201), in turn, is supplied with water through the water supply point to the detection and/or extinguishing means network of the inner blade section (39) which makes use of the percolated water through the outlet to the heat exchange network (25) visible in FIG. 12, which assumes, in this embodiment, the function of supplying the branches of the FFSS network present in the inner blade sections (201).

In turn, the specialties present in the hollow channel for the passage of networks of different specialties (38) can be supplied directly from electrical networks, telecommunications networks, water supply, gas supply or other networks, either public or from another domain, present in the outside of the building. All of these enter through the specialty networks entry point in the inner blade section (39), run through the gangway for the passage of networks of different specialties (38) and exit to the points where they are needed at each specialty network outlet point of the inner blade section (42). In the present embodiment of the invention, there is at least one such exit per floor. In order to increase safety and the availability rate and reduce the waste of water and gas that runs through the pipes and conduits in the hollow channel for the passage of networks of different specialties (38), all primary networks present therein can be sensorized in order to detect in real time water and/or gas leaks. This sensing, largely achieved with the presence of humidity and gas detectors, takes advantage of the leak tightness of the blade sections used and makes use of the reading capacity by contact in a hollow area, to detect leaks and trigger alarms for those who manage the building's infrastructure.

In a preferred embodiment, the foundations can be carried out by using the rings from a wind turbine, with the possibility of parallel execution of the balance beams. This could also comprise the installation of at least one central column that fulfils the function of the rigid core of the building structure, and the positioning of a plurality of inner sections of the blades of said wind turbine.

Also in a preferred embodiment, the construction of the internal structure of the building may constructively include floor and roof slabs in order to guarantee the correct positioning of the outer blade sections and the “crowning” panels with the central tower.

1. A modular building characterized in that it comprises a constructive structure composed of wind turbine segments, said constructive structure comprising at least:
a set of foundation rings, structurally adapted to a-ground which supports the building;
a foundation balance platform, mechanically connected to the set of foundation rings;
a set of outer support structures;
a set of upper support structures, placed parallel in a position superior to the foundation balance platform, and guaranteeing a mechanical connection to the set of outer support structures; and
a support structure, positioned centrally in relation to the foundation balance platform, mechanically connected to said foundation balance platform and to the set of upper support structures.

2. The modular building according to claim 1, wherein the set of foundation rings and/or the support structure comprise transverse annular sections of at least one wind turbine tower.

3. The modular building according to claim 1, wherein the foundation balance platform comprises at least one shape selected from circular, oval, rectangular, parallelepiped or triangular.

4. The modular building according to claim 1, wherein the set of outer support structures comprises at least one inner blade section of at least one wind turbine.

5. The modular building according to claim 1, wherein the set of upper support structures comprises at least one outer blade section of at least one wind turbine.

6. The modular building according to claim 1, wherein the mechanical connection between the support structure and the set of upper support structures comprises a blade connection and bearing support, and a lower expansion joint.

7. The modular building according to claim 1, wherein the set of upper support structures comprises a plugging panel and an upper expansion joint mechanically connected thereto in order to promote reinforcement of the mechanical connection with the support structure.

8. The modular building according to claim 1, wherein the support structure comprises at least one elevator adapted to an internal structure thereof.

9. The modular building according to claim 1, further comprising a fluid pressurized hydraulic system adapted to the constructive structure to promote heat dissipation or heating thereof.

10. The modular building according to claim 1, wherein the inner blade sections comprise inner areas adapted to house a fire fighting and safety system.

11. The modular building according to claim 1, wherein the inner areas of the inner blade sections comprise conducts, pipes and/or cabling of different specialties.

12. The modular building according to claim 1, wherein the lower expansion joint and/or the upper expansion joint comprise cork.

13. The modular building according claim 1, further comprising at least one floor slab adjacently located in a parallel position with respect to the foundation balance platform, in a parallel position underlying the set of upper support structures, and dimensionally equal to at least one floor slab.

14. A method of construction of a modular building according to claim 1, comprising the steps of:
i. connecting the inner blade sections with the outer foundation rings through anchor bolts or threaded anchors embedded in the filling material of the foundation rings;
ii. connecting the support structure and the central foundation ring through anchor bolts or threaded anchors embedded in the filling material of the foundation rings;
iii. adapting a lower expansion joint to the blade connection and bearing support by means of a set of pins passing through the holes therein;
iv. drilling the widest end of each outer blade section promoting the engagement of the bearing support pins with the blade connection and bearing support;
v. fixing the pins by means of rivets, or another suitable fastening system, after fitting and aligning each of the outer blade sections;
vi. placing the plugging panel of the blade connection over the upper expansion joint by means of welding, riveting, screwing, or other technically suitable means;
vii. installing the finishing panel on top of the structure;
viii. installing an expansion joint at each existing intersection point between the top of each inner blade section and the outer blade section that fills the connection area between said blade sections, said expansion joint being comprised of cork, or a material with similar properties, to promote strain recovery due to its negative contraction properties.

15. (canceled)
